(19) United States
(12) Patent Application Publication
(10) Pub. No.: US 2014/0274362 A1
(43) Pub. Date: Sep. 18, 2014

(54) Player Recommendation For Playing Online Game

(71) Applicants: Anshul Dhawan, San Francisco, CA (US); Serge Vladimiroff, San Francisco, CA (US); Sergey Perov, San Francisco, CA (US); John Ejike-Nwogu, San Francisco, CA (US); Jason Orcutt, San Francisco, CA (US)

(72) Inventors: Anshul Dhawan, San Francisco, CA (US); Serge Vladimiroff, San Francisco, CA (US); Sergey Perov, San Francisco, CA (US); John Ejike-Nwogu, San Francisco, CA (US); Jason Orcutt, San Francisco, CA (US)

(21) Appl. No.: 13/840,369

(22) Filed: Mar. 15, 2013

(51) Int. Cl. A63F 13/12; G07F 17/32

(52) U.S. Cl. CPC A63F 13/12; G07F 17/3276
USPC 463/29

(57) ABSTRACT

Methods, systems, and computer programs are presented for recommending a list of players for playing an online game. The method includes receiving a request to join an online game currently being played by a plurality of players. In response to the request, player attributes of the plurality of players playing the online game are gathered, in substantial real-time. A subset of players matching at least two of the player selection parameters with the player attributes of the players, is identified. The subset of players is returned as a list of recommended players to a client device for rendering. The returned list includes options to select one or more players and to join the selected players in playing the online game.

### BACKGROUND

1. Field of the Invention

The present invention relates to methods for improving social interactions in online games.

2. Description of the Related Art

Online games that allow players to interact with other players have become popular. As a result, some online games have millions of players playing the online game simultaneously at any given time. Online game operators, often referred to as social game operators, harness the power of online social networks to design games and tools to allow players to interact with their friends within the games. For example, in some online games, such as online poker games, a user may be able to use the online game tools to determine the games that are popular with his/her friends and select to play the online game based on popularity within his/her social circle.

The current tools provided limited capabilities in allowing a user to play a game with other users. For example, when the user is interested in broadening his playing skill and play an online game, it is hard to determine which players are playing the online game, which players have the attributes that the user is looking for and which set of players that have the desired attributes are willing to allow the user to join. It would, therefore, be beneficial to have a tool that provides visibility to the different attributes of players that are playing an online game and allows a user to select one or more players with the desired skill sets to enable the user to join the online game of the selected players in order to enrich the user's game experience.

It is in this context that embodiments arise.

### SUMMARY

Several embodiments are disclosed for providing a tool to receive a request from a user to join an online game that includes filtering options. In response to the request, information related to the plurality of players currently playing an online game is gathered based on the received filtering options. The tool is used to match the attributes of the plurality of players to the filtering options and to present a subset of players whose attributes match the filtering options, to the user to select for playing the online game. The filtering options are in the form of player selection parameters that identify the desired attributes of the players that the user is looking for playing the online game. Additional selection tools may also be provided to further refine the subset of players presented to the user for playing the online game. The user can join and play the online game by selecting a player from the subset to have a rich game playing experience. It should be appreciated that the present embodiments can be implemented in numerous ways, such as a method, an apparatus, a system, a device, or a computer program on a computer readable medium. Several embodiments are described below.

In one embodiment, a method for recommending a list of players for playing an online game is disclosed. The method includes an operation of receiving a request from a user to join an online game that is currently being played by a plurality of players. The request includes one or more player selection parameters that define filtering options for filtering the plurality of players currently playing the online game. Player attributes associated with each of the plurality of players that are currently playing the online game are gathered in substantial real-time, in response to the request received from the user. A subset of players is identified from the plurality of players by matching the player selection parameters with the player attributes associated with each of the plurality of players. The identified subset of players is returned as a list of recommended players for rendering on a user device to enable the user to select specific ones of the players to join and play the online game.

In another embodiment, a method for recommending a list of players for playing an online game is disclosed. The method includes an operation of receiving a request from a user to join an online game currently being played by a plurality of players. The request includes one or more player selection parameters that define filtering options for filtering the plurality of players currently playing the online game. Player attributes associated with each of the plurality of players that are currently playing the online game are gathered in substantial real-time, in response to the request received from the user. A subset of players is identified from the plurality of players by matching two or more of the player selection parameters with the player attributes associated with each of the plurality of players. The identified subset of players is returned as a list of recommended players for rendering on a user device. A selection of one or more players from the list of recommended players to join for playing the online game, is received. A determination is made to see if a maximum number of players for playing the online game has been reached in one or more groups in which the selected ones of the players are members. If number of the players playing the online game in the select one of the groups is less than the maximum number of players, the user is allowed to join the select group of players in playing the online game. Number of players in the select group is updated to account for the user joining the group, in substantial real-time.

In yet another embodiment, a non-transitory computer-readable storage medium with program instructions embedded thereon for recommending a list of players for playing an online game, is disclosed. The storage medium includes program instructions for receiving a request to join an online game currently being played by a plurality of players. The request includes one or more player selection parameters. The storage medium also includes program instructions for gathering, in substantial real-time, player attributes associated with each of the plurality of players that are currently playing the online game, in response to the request received from the user. The storage medium further includes program instructions for identifying a subset of players from the plurality of players by matching two or more player selection parameters with the player attributes associated with each of the plurality of players obtained in substantial real-time and program instructions for returning the subset of players as a list of recommended players for rendering on a user device. The returned list includes options for selecting one or more players by the user. The selection of the players by the user results in the user joining the selected players in playing the online game.

Other aspects will become apparent from the following detailed description, taken in conjunction with the accompanying drawings.

### BRIEF DESCRIPTION OF THE DRAWINGS

The embodiments may best be understood by reference to the following description taken in conjunction with the accompanying drawings.

FIG. 1 illustrates a simplified block diagram of a system used for providing a recommended list of players for playing an online game, in one embodiment.

FIG. 2 illustrates the various modules within the system that are used in generating a recommended list of players for playing an online game, in one embodiment.

FIGS. 2a-1 and 2a-2 illustrates a sample webpage of an online game for selecting player attributes to identify players to join and play the online game, in one embodiment.

FIG. 3 illustrates a sample matching of player attributes to player selection parameters and user attributes received in a request using a match refiner algorithm to generate the recommended list of players, according to one embodiment.

FIG. 3a illustrates a sample webpage user interface for the online game describing recent player list, in one embodiment.

FIG. 4 illustrates a sample matching of player attributes to play selection parameters and user attributes received in a request using a hierarchical matcher algorithm to generate the recommended list of players, according to one embodiment.

FIG. 5 illustrates sample webpages 5a-5d for adjusting a visibility option for a user while rendering featured recommended list of players for the online game, according to one embodiment.

FIG. 6 illustrates a flowchart of various operations involved in providing a recommended list of players for playing an online game, according to one embodiment.

FIG. 7 illustrates a flowchart of various operations involved in providing a recommended list of players for playing an online game, according to an alternate embodiment.

FIG. 8 illustrates an implementation of a Massively Multiplayer Online (MMO) infrastructure, according to one embodiment.

FIG. 9 illustrates an example network environment suitable for implementing embodiments.

FIG. 10 illustrates an example computer system for implementing embodiments.

### DETAILED DESCRIPTION

Various embodiments are described herein that engages a tool to receive player selection parameters for joining an online game, gather player attributes of a plurality of players currently playing the online game in substantial real-time, identify a list of players whose player attributes match the player selection parameters and to render the list of recommended players at a display device of a client device of a user. The list enables the user to select and join the one or more of the players currently playing the online game. It will be apparent, that the present embodiments may be practiced without some or all of these specific details. In other instances, well known process operations have not been described in detail in order not to unnecessarily obscure the present embodiments.

FIG. 1 illustrates a simplified block diagram of a system, in one embodiment, providing a tool for receiving a request from a client device 100 over a network 300, such as the Internet. The request includes player selection parameters. The client device 100 includes a display device 110 to receive and render a webpage 112 user interface of an online game, such as a poker game, and to receive player selection parameters for the online game specified by a user. The client device 100 may be any type of computing device that runs client-side computer programs, such as browser software or any other client-side computer program(s), to access a website of the online game on a server 200 over the network 300. The webpage 112 for the online game may be accessed directly through the website of a publisher of the online game or through an embedded link within a webpage of a social networking site. The webpage 112 user interface serves as a portal for accessing various features of the online game. In some embodiments, the game portal is also termed a “lobby” of the online game by the online game community.

The server 200 includes a recommendation algorithm 210 that provides access to the online game over the network 300. The recommendation algorithm includes processing logic that is executed by a processor of the server 200 and is configured to receive the request from the client 100, process the request and return a recommended list of players to the client 100 for user selection along with an user interface for rendering the recommended list and for receiving the user selection. To assist in processing the request and in generating a recommended list of players, the recommendation algorithm 210 includes a plurality of logic modules. An exemplary list of logic modules includes a request analyzer module 220, a player attributes accumulator module 230, an attribute analyzer module 240 and a recommendation list generator module 250. It should be noted that the aforementioned list of logic modules is exemplary and that additional or fewer logic modules may be included within the recommendation algorithm 210 to process the request and provide the list of recommended players to the client. Additionally, one or more of the aforementioned modules may be integrated with other modules and/or one or more sub-modules may be provided within the one or more modules to perform different level of analysis during processing of the request from the client. Some exemplary sub-modules within the one or more modules are described in detail with reference to FIG. 2.

Continuing to refer to FIG. 1, the request analyzer module 220 is configured to receive the request for joining other players that are currently playing the online game, from the client. The request is processed to determine one or more user attributes of the user generating the request and one or more player selection parameters that define the minimum attribute requirements of the players desired by the user interested in joining the online game.

The player attributes accumulator 230 is configured to obtain, in substantial real-time, the player attributes of the plurality of players that are currently playing the online game. The attributes accumulator may interact with online game data 402, over the network 300, to obtain the player attributes of the players currently playing the online game. The online game data 402 is a repository configured to receive, store and update dynamically changing attributes of the plurality of players currently playing the online game transmitted by a plurality of client devices' 100-a display devices 110-a.

The player attribute information obtained by the attributes accumulator from the online game data 402 is analyzed by the attribute analyzer module 240. In the analysis phase, different attributes of each player are identified and are categorized into respective player attribute buckets 404. In some embodiments, a player attribute may be categorized under more than one bucket.

The recommendation list generator 250 matches the player attributes with the user attributes and player selection parameters identified in the request by the request analyzer 220. The recommendation list generator obtains the player attributes from player attribute buckets. A list of players, whose attributes match the player selection parameters/user attributes, is generated by the recommendation list generator. The generated list of recommended players is returned to the client device 100, along with a rendering interface, such as a featured player list interface 114, for rendering on the client device's 100 display.

In one embodiment, in addition to obtaining the information related to the players/user from the attribute analyzer 240 and request analyzer 220, the recommendation list generator 250 may also obtain pre-defined game parameters and user-defined parameters of the online game from game parameters data store 406. The pre-defined game parameters may be used as an input during the generation of the recommended list of players. For instance, the game related parameters may define maximum number of players that can play within a group for an online game, maximum levels that can be attained in game play, allowable betting stakes of the group, minimum and maximum buy-in to participate in the online game, speed or other variant of the online game, etc., to name a few. The aforementioned list of game parameters is exemplary and should not be considered restrictive. One or more of the game related parameters may include parameters defined by the players currently playing the online game and the same can be retrieved from the game parameters data store 406 during generation of the recommended list of players.

In one embodiment, the recommendation list generator 250 may also interact with social media data 408 in order to determine game-related interaction between the players and between each of the players and the user. For instance, the social media data 408 may be queried to obtain information about each of the players' previous online game interactions with the user. The social media data may provide information, such as dates/times of online game play between the user and the player, frequency of play between the player and the user, amount of time spent playing, last time the player played with the user, etc. Additionally, popularity of each player in the online game community, the type and quantity of interactions between each player and other players, etc., are also gathered from the social media data. The recommendation list generator 250 may use this information from the social media data 408 to rank the players within the generated list that is returned to the client along with user interface to render the list.

The online game data 402, player attribute bucket 404, game parameters data store 406 and social media data 408 may be local to the server 200 or may be accessed remotely over the network 300.

In response to the rendering of recommended list of players at the user interface 114 of the client 100, interactions by the user are monitored and tracked at the user interface 114 of the client device 100. The user's interactions may be directed toward selection of one or more players from the generated list that the user is interested in joining and playing the online game. In response to the user's selection, the recommendation algorithm 210 returns an online game interface 116 for rendering at the user's client device 100 to enable the user to join the selected player(s) in playing the online game. The selected players' attributes meet the requirements of the user as specified in the request, allowing the user to have a rich game playing experience. It should be noted herein that the players selected for the list and for playing the online game are ones that are not socially related to the user through any social media networks but are players that have previously played the online game with the user at least once.

FIG. 2 illustrates the various modules/sub-modules that are engaged in providing a list of recommended players in response to a request from a user for joining one or more players currently playing the online game. The client-device 100 includes a user interface 110 through which a user accesses a webpage of a website of the online game that the user is interested in playing. In response to the user accessing the webpage, the online game's user interface 112 is returned for rendering at the client device 100. The user interface 112 allows a user to select one or more player selection parameters by providing different options. A sample online game's webpage user interface 112 providing different player selection parameter options is illustrated in FIGS. 2a-1 and 2a-2.

In one embodiment, one of the options included in the user interface is a geo location selection option that the user wants to be identified with for playing the online game. The user has the option to select a specified default geo location of the user or select an alternate geo location for playing the online game. In one embodiment, the option to choose between the default geo location or select an alternate geo location is presented in the form of a radio button. The radio button option is exemplary and should not be considered restrictive. Other forms of selection option, such as a drop-down list, fillable edit-box, etc., may be used. When the user selects the default geo location option by selecting the “Yes” radio button, a pre-defined geo location associated with the user is used for identifying the players for the online game. When the user selects the “No” radio button at the default geo location option, as illustrated in FIG. 2a-1, the user is provided with an option to select an alternate geo location to associate with the user, as illustrated by box 271 in FIG. 2a-2, so that the recommendation algorithm on the server can use the alternate geo location for providing a recommended list of players for the user that corresponds to the alternate geo-location.

In one embodiment, global positioning system (GPS) coordinates of the client device may be used by the algorithm to define the alternate geo location. The alternate geo location identified using the GPS coordinates is different from the default geo location that is associated with the user. In addition to providing an alternate geo location based on GPS coordinates, the algorithm may also provide a drop-down list and allow the user to specify the alternate geo location for associating with the user. The geo location specified by the user using the drop-down list may be same as or different from the geo location that is associated with the GPS coordinates of the client device. The algorithm, hence, provides the user flexibility to associate with any geo location and this flexibility enables the user to relate to players from any geo location to join and play the online game.

FIGS. 2a-1 and 2a-2 also illustrate other exemplary player selection parameter options provided by the algorithm and made available to the user in the user-interface, in response to the request to join an online game. The listed options should not be considered exhaustive. Fewer or additional parameters may be provided at the user interface for user selection based on the online game. In addition to the various selection parameter options, the user interface also includes logical connector options, as indicated in box 272. The logical connector may include an “AND” option to connect more than one selection parameter selected by the user in the user interface and an “OR” option to select one of two selected parameters. The logical connector options, illustrated in FIGS. 2a-1 and 2a-2, are exemplary and should not be considered restrictive. The logical connector for combining attributes may be any logical connector or combinations thereof. For example, the logical connectors may be one or more of logical AND, logical OR, logical NOT, logical XOR, etc.

Referring back to FIG. 2, when a user completes the selection of player selection parameters, the selection parameters are communicated from the client device 100 to the recommendation algorithm 210 executing on the server device 200, over the network 300, in the form of a request for joining the online game. The request analyzer module 220 within the recommendation algorithm 210 receives the selection parameters of the request and analyzes the selection parameters to identify the various attributes associated with the player and the user. A user attribute detector 222 within the request analyzer 220 analyzes the parameters received in the request to detect user-specific attributes, such as user identifier, user selection of online game, user's default geo location, user's GPS related geo-location, alternate geo-location, etc., to name a few. A player selection parameter analyzer 224 within the request analyzer 220 also analyzes the parameters in the request to identify player-specific attributes defined by the user for selecting players currently playing the online game at the specified geo-location for the user to join and play the online game. The user attributes and player attributes identified from the information provided in the request are forwarded to a recommendation list generator module 250 to use as input in generating the recommended list of players for the user to join and play.

In response to the request received from the client device 100, the recommendation algorithm 210 triggers a player attributes accumulator 230. In response to the trigger, player attributes accumulator 230 retrieves information related to a plurality of players that are currently playing the online game at a geo location specified in the request from an online game data 402. The online game data 402 is a repository storing dynamically changing data gathered from the plurality of players, in substantial real-time, for each of the online games played by the various players. A player attributes retriever 232 within the triggered player attributes accumulator 230 queries the online game data 402 and obtains player attributes of a plurality of players that are currently playing the specific online game at the geo location defined in the request, in substantial real-time.

The information gathered by the player attributes retriever 232 is analyzed and organized by the attribute analyzer 240. An attribute categorizer 241 within the attribute analyzer 240, identifies the different attributes associated with the players and categorizes each of the players into respective categories within attribute buckets data store 404. The attribute categorizer 241 includes a plurality of modules with each module categorizing a different attribute of the players. Some of the exemplary categorizing modules include a geo location analyzer module 242, a level detector module 244, a chip stack analyzer module 245, a stake analyzer module 246, and a social data analyzer module 248. The above list of categorizing modules is exemplary and should not be considered exhaustive or restrictive. Fewer or additional categorizing modules may be implemented depending on the attribute of the player that needs to be categorized. Along similar lines, one or more of the above list of categorizing modules may be integrated into other categorizing modules and the integrated categorizing module may be used to categorize the respective attributes of the players.

The different modules within the attribute categorizer 241 may categorize the player into more than one attribute bucket 404 based on the attributes of the player. For instance, the geo location analyzer 242 may categorize the player under a first bucket based on the default geo location associated with the player, under a second bucket based on an alternate geo location specified by the player, and a third bucket based on a geo location identified by the current GPS coordinates of the client device when the geo location identified by the GPS coordinates is different from the default or alternate geo locations. Still further, for each geo location, the geo location analyzer 242 may categorize the player into multiple geo location buckets arranged in a hierarchical manner. For example, in one embodiment, the geo-location (San Jose, Calif.) attribute of a player may be used to categorize the player into a plurality of buckets, such as a city bucket (San Jose bucket), a county bucket (Santa Clara county bucket), a state bucket (California bucket), a country bucket (U.S.A. bucket) and continent bucket (North America bucket). In another embodiment, the player may be categorized into a sub-bucket within a hierarchy of sub-buckets defined within a main bucket. For instance, for the above example, a player from San Jose may be categorized under a sub-bucket San Jose which is a sub-set of Santa Clara sub-bucket, which in turn is a subset of the California sub-bucket, which, in turn, is a sub-set of the U.S.A. sub-bucket within the North America main bucket.

Similarly, a level detector module 244 uses the game level attribute of the player to categorize the player into one or more buckets/sub-buckets. For example, the player that has mastered the online game up to game level 5 may be categorized by the level detector 244 under a specific level bucket, such as the level-5 bucket, and may also categorize the player under a level range of 0-9 bucket, under a level range of 0-20 bucket, etc.

Chip stack analyzer module 245 may be used to analyze the chip stack of each player that is currently playing the online game and categorize the players into appropriate buckets. The chip stack analyzer analyzes the way the stacks are arranged by a user and categorize the player accordingly. Similarly, stake analyzer module 246 may be used to analyze the stake playing style of the player. The stake analyzer module 246 includes a stake similarity detector 246-a that tracks the stake that the player begins with and also during online game play and determines if the stake level remains the same, changes during the game play, changes based on level of play mastered, or changes every time the player plays the online game. Based on the determination from the stake similarity detector 246-a, the player may be categorized under appropriate buckets by the stake analyzer module 246. The stake analyzer module 246 also includes a play style detector module 246-b to keep track of the way each player has historically bet in the online game and categorizes the play style of each of the player accordingly. For instance, does a player go “All-in” every time he/she plays, how frequently does he/she go all-in, how frequently does he raise his/her stake during the online game play, how such plays are based on the chip stack, his/her skill level in the online game, and list of other players and their skill level that he/she is playing against, etc. Such information for the player is collected over time during the player's online game play and is used in categorizing the player into appropriate buckets.

The social data analyzer module 248 within the attribute categorizer 241 is used to categorize the players based on the social interaction information obtained for each player. A play determinator module 248-a within the social data analyzer 248 is used to determine each player's frequency of playing the online game with another player, last time the player played with the other player, the amount of time the player spent in playing the online game with the other player, etc. This information is collected from social media data repository 408 and used in categorizing each of the players that are currently playing the online game.

The social data analyzer module 248 also includes a social behavior analyzer module 248-b that tracks the social interaction of the player with other players during the online game, the popularity of the player amongst other players of the online game, etc., and uses the information from the social interaction to categorize the player into appropriate buckets.

It should be noted that the players' categorization into respective buckets is dynamic and may change over time based on the continuity of the online game play by the players. As a result, the attribute buckets that each player is associated with may also change over time to reflect the change in the player's attributes. For example, a player may be removed from one game level bucket and put into another level bucket as and when the game level of the player changes. Information associated with player categorization related to the various attributes is stored in the player attribute bucket data store 404. The player attribute bucket data store 404 may be local to the server or may be remote and accessed over the network 300. The information from the player attribute bucket data store 404 is provided as second set of inputs to the recommendation list generator 250 in generating the recommended list of players for the user to join and play the online game. It should be noted that the categorization of each player playing the online game is performed in substantial real-time during online game play to capture the game status of each player and such information is made available at the time the request is received for generating the list of recommended players.

The categorization information of the plurality of players is used by the recommendation list generator 250 to identify a subset of players. The subset of players are identified by matching the player attributes of the plurality of players with the user attributes and player selection parameters identified in the request. The recommendation list generator 250 includes a plurality of modules to assist in the matching process.

A matching algorithm 252 within the recommendation list generator 250 is configured to perform the matching of the player attributes with the player selection parameters from the request. The recommendation list generator 250 uses the information provided by the request analyzer identifying the user attributes, player selection parameters and logical connectors for the player selection parameters (as the first set of input) in order to identify the players of the online game that the user desires to join and play the online game. The player selection parameters specify the player attributes of the players desired by the user. In one embodiment, the matching algorithm 252 may use a “refine” form or a “hierarchical” form of matching to match the selection parameters to the player attributes of the plurality of players.

In this embodiment, the matching algorithm 252 includes a match refiner module 252-a to perform the refine form of matching to identify the list of players for joining and playing the online game. The match refiner 252-a performs an initial match to identify an initial list of players by selecting one of the player selection parameters to match with the corresponding players' attribute. Once the initial list of players is identified, the match refiner module 252-a begins to iteratively refine the initial list of the players by matching additional player selection parameters of the request with the corresponding player attributes of the players in the initial list, based on the associated logical connector. The refining of the initial list is performed one player selection parameter at a time till all player selection parameters in the request have been matched. In order to identify and refine the list of players, the match refiner 252-a queries the appropriate player attribute buckets 404 for the selected ones of the parameters and adjusts the list of players based on the logical connector associated with the parameters.

Each of the player attribute buckets 404 receives data in substantial real-time from the client devices associated with the plurality of players, as and when one or more of the player's attributes change during the online game play, and updates the data in the respective player attribute buckets 404. The updating of the data in the player attribute buckets 404 may entail moving the player from one bucket and accounting the player under a different bucket for a particular attribute. The match refiner 252-a uses the updated data from the player attribute buckets 404 in generating and refining the list of players for the request.

A sample matching using the logic within the match refiner module 252-a is illustrated in FIG. 3. As shown, an initial determination is made to identify the total number of online game players (12,500,000) that are playing online games at the time the request for information related to a particular online game was received by the recommendation algorithm 210 executing on the server 200. The match refiner module 252-a then begins to refine the list of online game players to identify the players playing the online game 1 (i.e., first parameter) identified in the request. The refined list after the first refinement includes a total of 2,500,000 players. The match refiner 252-a further refines the number of players (50,000 players) that are playing the online game 1 in the geo location 1 (i.e., second parameter) specified in the user attributes of the request and filters out the players that do not match the specified geo location. The match refiner 252-a continues to iteratively refine the number of players based on the different parameters specified in the request to finally identify a list of 65 players that match all of the parameters in the request, as identified by box 302 in FIG. 3. In one embodiment, this list of 65 players may be further refined to identify players that have interacted (i.e. played the online game) with the user originating the request, within a pre-defined period, if the user's request specifies the play period parameter, to identify 27 players, as illustrated by box 304 in FIG. 3.

In one embodiment, the matching algorithm 252 includes a hierarchical matcher module 252-b to perform hierarchical matching in order to identify the list of players for the user to select to join and play the online game. The hierarchical matcher module 252-b may be used when not enough players are identified by the match refiner module 252-a for any one or more of the player selection parameters. It should be noted that not all selection parameters need to be processed through hierarchical matcher module 252-b. The matching algorithm 252 may include logic to determine which ones of the player selection parameters can be processed using the hierarchical matcher and which parameters can be processed using just the match refiner. Based on the logic within the matching algorithm 252, in one embodiment, when not enough players are identified for a selected one of the player selection parameter, such as geo location parameter, the match refiner module 252-a may hand over the matching process to the hierarchical matcher module 252-b to enable the hierarchical module 252-b to find players currently playing the online game and whose attributes match a broader aspect of the player selection parameter.

In this embodiment, the hierarchical refiner 252-b begins the matching process by determining the player selection parameter that needs to undergo hierarchical matching and the number of players that match the initial selection parameter. When the number of players matching the selected one of the player selection parameters is zero or below a pre-defined threshold value, the hierarchical refiner 252-b tries to iteratively match at the next hierarchical level for the selected parameter till sufficient number of players are identified matching a broader aspect of the selected parameter. When after all the iterations, there is no match of players, a warning, error or informational message may be communicated through the matching algorithm to the client device indicating that there was none or insufficient number of players matching the selected one of the parameter that are playing the online game at the time the request was received at the recommendation algorithm on the server.

If, on the other hand, the particular attribute of sufficient number of players match the broader aspect of the selected parameter, the hierarchical matcher 252-b will identify the list of players with matching attributes and forward information related to the list of players to the match refiner module 252-a for further refining. In order to identify the list of players, the hierarchical matcher 252-b queries the appropriate player attribute bucket 404 when matching to the broader aspect of the selected one of the parameters to identify the list of players. Upon receiving the list of players from the hierarchical matcher 252-b, the match refiner 252-a will continue the matching process by iteratively matching other selection parameters, one selection parameter at a time, as mentioned above till all player selection parameters in the request have been matched.

A sample hybrid matching using the logic within the hierarchical matcher module 252-b and the match refiner module 252-a is illustrated in FIG. 4. As shown, an initial determination is made by the match refiner module 252-a to identify the total number of online game players (22,500,000) that are playing a plurality of online games at the time the request was received by the recommendation algorithm 210 executing on the server 200. The match refiner module 252-a uses this number and begins to refine the list of online game players by identifying a total of 7,500,000 players who are playing online game 1 specified in the request received from the user. From this list, the match refiner 252-a tries to identify players that are playing the online game 1 in the geo location 1 specified in the user attributes portion of the request by querying the geo location 1 attribute bucket 404. The query may return no records or very few records, indicating that there are no players or very few players that are currently playing the online game 1 in geo location 1.

In one embodiment, when a low number of players is returned, the match refiner module 252-a may continue the match process by matching other player selection parameters to the selected players attributes. With a low number of players matched for a particular parameter, when the match refiner module 252-a tries to match additional parameters, it is more than likely that the list at the end of the refinement process may turn out to be empty indicating that the algorithm could not identify any players whose attributes match the other parameters received in the request. In order to avoid such scenarios from occurring or in order to provide more options for the user to select from, a threshold value may be established for including a minimum number of players to be returned in the list for selected one or more of the parameters. The threshold value may specify the preferred minimum number of player records that is to be identified in order to consider a successful match for that parameter. Thus, when the number of players whose attributes match such parameters is zero or less than the threshold value, the hierarchical matcher module may be triggered. The parameters that might be linked to the threshold value may depend on the online game, popularity of the online game and the number of players playing the online game at any given time. For example, in one embodiment, the hierarchical matcher may be triggered when not enough records are identified for the specified geo location attribute.

When the hierarchical matcher 252-b is triggered, the hierarchical matcher 252-b will try to match the geo location 1 at the next hierarchical level of the geo location 1. In the embodiment illustrated in FIG. 4, the geo location 1 may be Sunnyvale, Calif., where zero player records were found. In this embodiment, the next hierarchical level for the geo location 1 is county level (i.e., county of Santa Clara). The hierarchical matcher 252-b tries to find players within the county of Santa Clara and may identify 2 players playing the online game 1 in the county of Santa Clara, as illustrated in FIG. 4. The threshold value for the geo location 1 of the online game 1 may be pre-defined to be a value 70, for example. In this example, the number of players returned (i.e., 2) is less than the threshold value of 70. As a result, the hierarchical matcher will continue the matching process by trying to match at the next hierarchical level of the geo location 1, which is the state level and identify about 80 players playing the online game in the State of California. Since the number of players matching the geo location 1 exceeds the threshold value of 70, the hierarchical matcher will suspend the matching process and return information related to the identified players to the match refiner 252-a to complete the match process with respect to other parameters.

The match refiner 252-a continues to iteratively refine the list of players returned based on the different parameters specified in the request to finally identify a list of 32 players that match all of the parameters in the request, as identified by box 302 in FIG. 4. It should be noted that the players that are selected for the list of recommended players must have interacted with the user generating the request, at least once in order to be included in the list. The list of 32 players identified by the hierarchical player may be further refined to identify players that have interacted (i.e. played the online game) with the user that originated the request, within a pre-defined period, if the user's request specifies such play period parameter, to identify 15 players, as illustrated by box 304 in FIG. 4.

Referring back to FIG. 2, in one embodiment, the matching algorithm 252 may interact with the generator algorithm 254 to obtain game related parameters and refine the recommended list of players further based on the game related parameters. The game related parameters identify the requirements of the game and/or specifications provided by one or more of the players playing the online game, such as maximum number of players allowed to play the game, minimum level required for joining a group in which each player is a member, stake requirements, speed or similar game-related attribute, minimum and maximum stakes allowed for each level, etc. The maximum player requirement, for example, may be in the form of number of players allowed for each table, in an online casino game, such as poker. A game configuration parameters module 254-b within the generator algorithm 254 will interact with the game parameters data store 406 to obtain the game related parameters that includes both pre-defined game-specific parameters and player-defined parameters for the online game and provide this information to the matching algorithm for processing the list of players.

In one embodiment, the refined list of players obtained from the matching algorithm is organized and returned to the client device for rendering without verifying to see if the group in which each player in the list is a member, has reached a maximum number of players allowed for the online game. Along with the list, the recommendation algorithm also returns a user interface to render the list of players and a selection option for selecting any one of the players from the list. In this embodiment, user interaction activity at the user interface is monitored. When the user selects any one of the players to join and play the online game by interacting at the selection option of a particular player at the rendering interface 114, the selection activity is transmitted to the recommendation algorithm on the server 200, which verifies to see if the attributes of the selected player meet the game requirements. As a result, upon receiving the selection activity, the recommendation list generator 250 in the recommendation algorithm 210 uses the game configuration parameter module 254-b to determine the requirements of the game and of the players playing the game. The requirements of the game are obtained by querying the game parameters data store 406 over the network 300, if remote, or directly if the game parameters data store 406 is local to the server 200. Using the game related parameters, the generator algorithm 254 of the recommendation list generator 250 may determine the maximum player requirement for the online game and if there is an open slot or seat in the group in which the selected player is a member. If an open slot is available, the user is allowed to join the selected player in playing the online game. For instance, in a casino game like poker, a maximum number of players at each table of poker may be set at 10. If the table where the selected player is playing has less than 10 players, the user may be allowed to join the game.

In another embodiment, the generator algorithm 254 will verify to see a group (i.e., a table set-up in the poker example) in which each player within the list is a member to determine if the respective player's group has an open slot, (i.e., open seat at each player's table in the poker example) or if the maximum number of players has been reached. The list of players is the list provided by the matching algorithm. If the maximum number of players has been reached in the group in which the player is a member (i.e., at the table in the poker example), then the player is filtered out of the list returned to the client device even though other attributes of the player and of the game have been met by the player's attributes. If, on the other hand, an open seat is available at the table of the player, the player is retained in the list. As a result, when the list of players is returned for rendering at the featured player list rendering interface 114 of the client device, the user can select any one of the players in the rendered list to join and play the online game. Further verification is not needed. Along with the list, the recommendation algorithm also returns a user interface to render the list of players and a selection option for selecting a player from the list. User interaction activity at the user interface is monitored. When the user selects any one of the players in the list, the user is provided with a game interface and is allowed to join and play the online game with the selected user.

In one embodiment, the list of players identified by the recommendation list generator 250 may be filtered based on social economy of a social network associated with the user. Each social network may include one or more economies and the recommendation list generator 250 uses this information to return the appropriate list of players, in response to the request. In this embodiment, the social economy of the user may be determined from user attributes of the user obtained in the initial request and only those players that are part of the social economy of the user are identified from the players attributes and returned in the recommendation list of players.

Continuing to refer to FIG. 2, the list of players generated and refined by the sub-modules within the matching algorithm 252 are organized using a ranker module 254-a. The ranker module sorts and ranks the players in the generated list based on a pre-defined ranking algorithm. The ranker module 254-a may use information from the social media related data store 408, such as popularity of each player in the list, number of other players each player interacts with during the online game play, etc., and/or player attributes, such as game level achieved by the player, etc., to sort and rank the player in the generated list.

Information related to the ranked and organized list of players is transmitted by the recommendation list generator module 250 to the client device 100 over network 300 along with a user interface, such as a “Featured Player list rendering interface” 114, for rendering the list of recommended players, in response to the request. The information related to the players returned to client device for rendering at the user interface of the client device may include one or more player attributes, such as the player identifier, profile image of the player, player level, stack of chips, to name a few. A selection option is provided at the user interface to allow the user to select a player for joining and playing the online game. FIG. 3a illustrates a sample webpage user interfaces returned to the client for rendering the recommended list of players that are currently playing the online game and whose attributes match the parameters received in the request from a user. The user interface also includes the selection option 306 provided to the user to enable the user to select a player for joining in playing the online game.

In addition to the selection option 306, the user interface returned with the list of players matching the player selection parameters may also include a visibility status indicator box 502 that provides options to the user to hide or display the user's attributes during online game play. The status indicator option allows the user to control the user's privacy by allowing the user to display or hide the users attributes and which attributes to hide or display to other players during the online game play. FIGS. 5A-5D illustrate the different states of the visibility status indicator within the box 502 provided in the user interface when the user decides to hide or reveal his/her attributes. In the example provided in FIGS. 5A-5D, the visibility status indicator in the box 502 includes a radio button for selecting to hide or reveal the user attributes of the user and appropriate informational messages/options to enable the user to identify and/or change his/her selection. It should be noted that the visible status indicator illustrated in FIGS. 5A-5D is exemplary and should not be considered restrictive. Other forms of visible status indicator to allow the user to hide or display the user attributes may be used in the user interface.

As illustrated in FIG. 5A, a user selects to make his/her attributes visible by checking a “Visible” button at the visibility status indicator box 502 in the user interface 114. Based on the user's selection to be visible, a “Visible” message is displayed at the user interface, indicating that the user's profile/attributes are visible. Based on this selection, one or more of the user's attributes are rendered alongside that of other players with whom the user has selected to play the online game. Additionally, a “Hide Me” option is provided to allow the user to change his/her mind and hide his/her attributes. When the user selects the “Hide Me” option, the visibility indicator at the user interface is updated by unchecking the “Visible” button, as illustrated in FIG. 5B, and the informational message, “You Are Now Hidden” is displayed for a pre-determined period of time (for example, for 5 seconds) and a second informational message “Hidden” is rendered, as illustrated in FIG. 5C. The second informational message (i.e., “Hidden”) is rendered till the time the user decides to change his/her visibility status and decides to become visible again, as illustrated in FIG. 5D at which time, the “Visible” button is checked and the informational message “You Are Now Visible” is rendered for the pre-determined period of time and then the “Visible” message is rendered as shown in FIG. 5A. As and when a user changes his/her visibility status indicator, the information is propagated to all the users in the group which the user joined to play the online game so that when each of the players in the group loads or refreshes the webpage, the user interface at the client device of each of the player either renders or hides the attributes of the user.

Upon rendering of the list at the display portion of the client device, user interaction at the user interface is monitored. When the user selects a player from the list to join by choosing the selection option 306 associated with the player, the user selection is returned to the recommendation algorithm. In response to the user selection, the recommendation list generator 250 provides the online game's interface 116 to enable the user to join and play the online game with the selected player, if the selected player's group has an open slot.

In addition to providing an interface for the user to play the game with other players in the group of the selected player, the game interface 116 also provides an area for social interaction between the user and the players. For instance, a chat window (not shown) may be provided alongside the area where the game interface is rendered to enable the user and the players to chat during the online game play. The game interface 116 may also provide an informational message to all players when the user joins the group for playing the online game. The informational message welcoming the user to the group, such as “Welcome John! Frank plays near you.”, may be rendered at the game interface 116 on the user's client device and an informational message indicating addition of a player to the group, such as “John just joined the group”, may be rendered at the user interface of the client device of each of the player's within the group that the user has joined for playing the online game.

User and other players interactions at the game interface during online game play are recorded and transmitted to the recommendation algorithm executing on the server. In response to receiving the interactions, the recommendation algorithm may update appropriate data stores so that the updated data store can be used for subsequent data mining.

With the aforementioned detailed description of the various embodiments, a method for providing a recommended list of players for playing an online game will now be described with reference to FIG. 6. The method begins at operation 610, wherein a request to join an online game currently being played by a plurality of players, is received. The request may be generated by a user interested in joining and playing the online game with other players that he has interacted with before but with whom the user is not socially connected. The request to join includes one or more player selection parameters defined by the user. The request also includes one or more attributes of the user. The player selection parameters and user attributes are used to filter the players that are currently online and playing a plurality of games.

Upon receiving the request, a recommendation algorithm executing on a server gathers, in substantial real time, player attributes of each of the players currently playing a plurality of online games as illustrated in operation 620. The recommendation algorithm may query online game data repository to obtain the player attributes of the different players. The online game data repository receives information related to dynamically changing attributes of the players captured during online game play, from each of the players' client device over the network and updates the respective players' attribute information stored within the repository. The algorithm first analyzes the player attributes of the plurality of players that was gathered in substantial real-time and categorizes the player attributes into a plurality of buckets and stores/updates this categorized information in a player attribute bucket data store as and when such data is received from the respective players' client device. This up-to-date game-related information is provided to the recommendation algorithm in response to the query.

The recommendation algorithm then compares the attributes of the players collected from the online game data against the player selection parameters of the request to identify a subset of players whose attributes match the player selection parameters, as illustrated in operation 630. In order to match the player attributes against player selection parameters, the recommendation algorithm analyzes the player selection parameters to determine user attributes and player attributes desired by the user. The algorithm then matches each selection parameter of the request with the corresponding player attribute of the plurality of players by using the categorized information in the various player attribute buckets to identify a subset of the players. The subset of players obtained through the matching process identifies the players that the user desires to join and play the online game.

The subset of players is returned to a client device of the user for rendering and selection by the user. The method concludes with the user's selection of a player from the list. The user's selection results in the user joining the selected player in playing the online game.

FIG. 7 illustrates an alternate method for providing a recommended list of players for playing on online game. The method begins at operation 710, wherein a request to join an online game that is currently being played by a plurality of players, is received from a user. The request from the user is directed toward identifying players that the user has interacted with before but is not socially connected. The request includes one or more player selection parameters defined by the user and one or more attributes of the user. The player selection parameters and user attributes are used to filter the players that are currently online and playing a plurality of games.

A recommendation algorithm executing on a server receives the request. In response to receiving the request, the recommendation algorithm collects player attribute information, in substantial real time, of each of the players currently playing a plurality of online games, as illustrated in operation 720. The recommendation algorithm may query online game data repository, which stores dynamically changing attributes of the players captured during online game play, to obtain the player attributes of the different players.

The recommendation algorithm then matches the attributes of the players retrieved from the online game data store with the player selection parameters of the request to identify a subset of players whose attributes match the player selection parameters, as illustrated in operation 730. The recommendation algorithm performs the match by first analyzing the player selection parameters to determine user attributes and player attributes desired by the user. The algorithm then retrieves categorized information related to player attributes of plurality of players maintained within a player attribute bucket data store. The recommendation algorithm then matches player selection parameters of the request with the corresponding player attributes of the plurality of players provided within the categorized information to identify a subset of the players.

The subset of players obtained through the matching process is returned to a client device as a recommended list of players for rendering, as illustrated in operation 740. The subset of players identifies the players that the user desires to join in playing the online game. Along with the subset of players, selection options for choosing one or more players from the list are also returned for rendering and user interaction.

User interactions at the selection options are monitored. The user interactions identify user's selection of player from the subset of players rendered at the client device. Selection of one or more players from the list is received by the recommendation algorithm, as illustrated in operation 750. The user selection identifies the user's interest in joining the selected player(s) and playing the online game.

In response to the selection received from the user, the recommendation algorithm determines game-related parameters to determine if the selected player's attributes meet the game-specific and user-defined requirements in order for the user to join the selected player in playing the online game. The recommendation algorithm may obtain the game-related parameters by querying game parameters data store. The game-related parameters identify the game-specific requirements and user-defined requirements. The recommendation algorithm determines if a group in which the selected player is a member has reached maximum number of players allowed for the online game by verifying the players attributes against the game related parameters, as illustrated in operation 760. For example, the player's attributes may identify a table at which the player is playing in an online casino game, such as poker, and may also provide the number of players at the table. The game-related parameters may identify the game-specific requirements, such as maximum number of players that is allowed at the table, etc., and user-defined requirements, such as the speed of the table, stake, etc.

The recommendation algorithm then determines if the number of players in the group associated with the selected player is less than the maximum number of players by comparing the number of players that are in the group against the maximum number of players allowed for the table. When the number of players in the selected group is less than the maximum number of players allowed, the recommendation algorithm will allow the user to join the selected player in playing the online game, as illustrated in operation 770. The method concludes with the algorithm updating number of players in the selected group to account for the user joining the group.

Interactions of the user and the players are recorded during online game play and respective attributes are identified and updated, in substantial real-time, to the respective online game data store, player attribute bucket data store and game-related parameters and social media data store to enable the algorithm to use the updated information for refining the list of players during subsequent requests from the user.

FIG. 8 illustrates an implementation of an online game infrastructure, according to one embodiment. The online game infrastructure 476 includes one or more game servers 458, web servers (not shown), one or more social network management servers 462, and databases to store game related information. In one embodiment, game server 458 provides a user interface 460 for players 452 to play the online game. In one embodiment, game server 458 includes a Web server for players 452 to access the game via web browser 454, but the Web server may also be hosted in a server different from game server 458. Network 456 interconnects players 452 with the one or more game servers 458.

Each game server 458 has access to one or more game databases 466 for keeping game data. In addition, a single database can store game data for one or more online games. Each game server 458 may also include one or more levels of caching. Game data cache 464 is a game data cache for the game data stored in game databases 466. For increased performance, caching may be performed in several levels of caching. For instance, data more frequently used is stored in a high priority cache, while data requiring less access during a session will be cached and updated less frequently.

The number of game servers 458 changes over time, as the gaming platform is an extensible platform that changes the number of game servers according to the load on the gaming infrastructure. As a result, the number of game servers will be higher during peak playing times, and the number of game servers will be lower during off-peak hours. In one embodiment, the increase or decrease of bandwidth is executed automatically, based on current line usage or based on historical data.

One or more social network management servers 462 provide support for the social features incorporated into the online games. The social network management servers 462 access social data 478 from one or more social networks 474 via Application Programming Interfaces (API) 472 made available by the social network providers. An example of a social network is Facebook, but it is possible to have other embodiments implemented in other social networks. Each social network 474 includes social data 478, and this social data 478, or a fraction of the social data, is made available via API 472. As in the case of the game servers, the number of social network management servers 462 that are active at a point in time changes according to the load on the infrastructure. As the demand for social data increases, the number of social network management servers 462 increases. Social network management servers 462 cache user data in database 468, and social data in database 470. The social data may include the social networks where a player is present, the social relationships for the player, the frequency of interaction of the player with the social network and with other players, etc. Additionally, the user data kept in database 468 may include the player's name, demographics, e-mail, games played, frequency of access to the game infrastructure, etc.

It is noted that the embodiment illustrated in FIG. 8 is an exemplary online gaming infrastructure. Other embodiments may utilize different types of servers, databases, APIs, etc., and the functionality of several servers can be provided by a single server, or the functionality can be spread across a plurality of distributed servers. The embodiment illustrated in FIG. 8 should therefore not be interpreted to be exclusive or limiting, but rather exemplary or illustrative.

FIG. 9 illustrates an example network environment 550 suitable for implementing embodiments. Network environment 550 includes a network 560 coupling one or more servers 570 and one or more clients 580 to each other. In particular embodiments, network 560 is an intranet, an extranet, a virtual private network (VPN), a local area network (LAN), a wireless LAN (WLAN), a wide area network (WAN), a metropolitan area network (MAN), a portion of the Internet, another network, or a combination of two or more such networks 560.

One or more links 552 couple a server 570 or a client 580 to network 560. In particular embodiments, one or more links 552 each includes one or more wired, wireless, or optical links 552. In particular embodiments, one or more links 552 each includes an intranet, an extranet, a VPN, a LAN, a WLAN, a WAN, a MAN, a portion of the Internet, or another link 552 or a combination of two or more such links 552.

Each server 570 may be a stand-alone server or may be a distributed server spanning multiple computers or multiple datacenters. Servers 570 may be of various types, such as, for example and without limitation, community server, web server, news server, mail server, message server, advertising server, file server, application server, exchange server, database server, or proxy server. Each server 570 may include hardware, software, embedded logic components, or a combination of two or more such components for carrying out the appropriate functionalities implemented or supported by server 570. For example, a web server is generally capable of hosting websites containing web pages or particular elements of web pages. More specifically, a web server may host HyperText Markup Language (HTML) files or other file types, or may dynamically create or constitute files upon a request, and communicate them to clients 580 in response to Hypertext Transfer Protocol (HTTP) or other requests from clients 580. A mail server is generally capable of providing electronic mail services to various clients 580. A database server is generally capable of providing an interface for managing data stored in one or more data stores.

In particular embodiments, one or more data storages 590 may be communicatively linked to one or more severs 570 via one or more links 552. Data storages 590 may be used to store various types of information. The information stored in data storages 590 may be organized according to specific data structures. In particular embodiments, each data storage 590 may be a relational database. Particular embodiments may provide interfaces that enable servers 570 or clients 580 to manage, e.g., retrieve, modify, add, or delete, the information stored in data storage 590.

In particular embodiments, each client 580 may be an electronic device including hardware, software, or embedded logic components or a combination of two or more such components and capable of carrying out the appropriate functionalities implemented or supported by client 580. For example and without limitation, a client 580 may be a desktop computer system, a notebook computer system, a notebook computer system, a handheld electronic device, or a mobile telephone. A client 580 may enable a network player at client 580 to access network 580. A client 580 may enable its player to communicate with other players at other clients 580. Further, each client 580 may be a computing device, such as a desktop computer or a work station, or a mobile device, such as a notebook computer, a network computer, or a smart telephone.

In particular embodiments, a client 580 may have a web browser 582, such as Microsoft Internet Explorer, Google Chrome, Or Mozilla Firefox, and may have one or more add-ons, plug-ins, or other extensions. A player at client 580 may enter a Uniform Resource Locator (URL) or other address directing the web browser 582 to a server 570, and the web browser 582 may generate a Hyper Text Transfer Protocol (HTTP) request and communicate the HTTP request to server 570. Server 570 may accept the HTTP request and communicate to client 580 one or more Hyper Text Markup Language (HTML) files responsive to the HTTP request. Client 580 may render a web page based on the HTML files from server 570 for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in Javascript, Java, Microsoft Silverlight, combinations of markup language and scripts such as AJAX (Asynchronous Javascript and XML), and the like. Herein, reference to a web page encompasses one or more corresponding web page files (which a browser may use to render the web page) and vice versa, where appropriate.

Web browser 582 may be adapted for the type of client 580 where the web browser executes. For example, a web browser residing on a desktop computer may differ (e.g., in functionalities) from a web browser residing on a mobile device. A user of a social networking system may access the website via web browser 582.

FIG. 10 illustrates an example computer system 650 for implementing embodiments. In particular embodiments, software running on one or more computer systems 650 performs one or more operations of one or more methods described or illustrated herein or provides functionality described or illustrated herein. Although methods for implementing embodiments were described with a particular sequence of operations, it is noted that the method operations may be performed in different order, or the timing for the execution of operations may be adjusted, or the operations may be performed in a distributed system by several entities, as long as the processing of the operations are performed in the desired way.

As example and not by way of limitation, computer system 650 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 650 may include one or more computer systems 650; be stand-alone or distributed; span multiple locations; span multiple machines; or reside in a cloud, which may include one or more cloud components in one or more networks. The one or more computer systems 650 may perform in real time or in batch mode one or more operations of one or more methods described or illustrated herein.

In particular embodiments, computer system 650 includes a processor 652, memory 654, storage 656, an input/output (I/O) interface 658, a communication interface 660, and a bus 662. Although this disclosure describes and illustrates a particular computer system having a particular number of particular components in a particular arrangement, embodiments may be implemented with any suitable computer system having any suitable number of any suitable components in any suitable arrangement.

In particular embodiments, processor 652 includes hardware for executing instructions, such as those making up a computer program. As an example and not by way of limitation, to execute instructions, processor 652 may retrieve (or fetch) the instructions from an internal register, an internal cache, memory 654, or storage 656; decode and execute them; and then write one or more results to an internal register, an internal cache, memory 654, or storage 656. The present disclosure contemplates processor 652 including any suitable number of any suitable internal registers, where appropriate. Where appropriate, processor 652 may include one or more arithmetic logic units (ALUs); be a multi-core processor; or include one or more processors 652. Although this disclosure describes and illustrates a particular processor, this disclosure contemplates any suitable processor.

In particular embodiments, memory 654 includes main memory for storing instructions for processor 652 to execute, or data that can be manipulated by processor 652. As an example and not by way of limitation, computer system 650 may load instructions from storage 656 or another source (such as, for example, another computer system 650) to memory 654. Processor 652 may then load the instructions from memory 654 to an internal register or internal cache. During or after execution of the instructions, processor 652 may write one or more results (which may be intermediate or final results) to the internal register or internal cache. Processor 652 may then write one or more of those results to memory 654. One or more memory buses (which may each include an address bus and a data bus) may couple processor 652 to memory 654. Bus 662 may include one or more memory buses, as described below. One or more memory management units (MMUs) reside between processor 652 and memory 654 and facilitate accesses to memory 654 requested by processor 652. Memory 654 includes random access memory (RAM).

As an example and not by way of limitation, storage 656 may include a Hard Disk Drive (HDD), a floppy disk drive, flash memory, an optical disc, a magneto-optical disc, magnetic tape, or a Universal Serial Bus (USB) drive or a combination of two or more of these. Storage 656 may include removable or non-removable (or fixed) media, where appropriate. In particular embodiments, storage 656 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these.

In particular embodiments, I/O interface 658 includes hardware, software, or both providing one or more interfaces for communication between computer system 650 and one or more I/O devices. One or more of these I/O devices may enable communication between a person and computer system 650. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these.

Communication interface 660 includes hardware, software, or both providing one or more interfaces for communication between computer system 650 and one or more other computer systems 650 on one or more networks. As an example and not by way of limitation, communication interface 660 may include a network interface controller (NIC) or network adapter for communicating with an Ethernet or other wire-based network or a wireless NIC (WNIC) or wireless adapter for communicating with a wireless network, such as a WI-FI network. As an example, computer system 650 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In particular embodiments, bus 662 includes hardware, software, or both coupling components of computer system 650 to each other. As an example and not by way of limitation, bus 662 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 662 may include one or more buses 662, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure that may store a computer program or data. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a Secure Digital card, a Secure Digital drive, or another suitable computer-readable storage medium or a combination of two or more of these, where appropriate. Herein, reference to a computer-readable storage medium excludes any medium that is not eligible for patent protection under 35 U.S.C. §101.

One or more embodiments can also be fabricated as computer readable code on a non-transitory computer readable medium. Herein, reference to software may encompass one or more applications, bytecode, one or more computer programs, one or more executables, one or more instructions, logic, machine code, one or more scripts, or source code, and vice versa, where appropriate.

The present disclosure encompasses all changes, substitutions, variations, alterations, and modifications to the example embodiments herein that a person having ordinary skill in the art would comprehend.

What is claimed is:

1. A method for recommending a list of players for playing an online game, comprising:
receiving a request to join an online game currently being played by a plurality of players, the request including one or more player selection parameters provided by a user generating the request, the player selection parameters defining filtering options for filtering the plurality of players currently playing the online game;
gathering, in substantial real-time, player attributes associated with each of the plurality of players that are currently playing the online game in response to the request received from the user;
identifying a subset of players from the plurality of players by matching at least two or more of the player selection parameters with the player attributes associated with each of the plurality of players; and
returning the subset of players as a list of recommended players for rendering on a user device, the returned list including options for selecting one or more players by the user, the selection of the players by the user resulting in the user joining the selected players in playing the online game.

2. The method of claim 1, wherein receiving the request includes analyzing the player selection parameters to identify one or more attributes of the user generating the request and one or more player attributes for selecting the subset of the players for playing the online game.

3. The method of claim 1, wherein each of the plurality of players is a player that has previously played with the user at least once.

4. The method of claim 1, wherein the player is a person who is not socially connected to the user.

5. The method of claim 1, wherein the player selection parameter is selected from a group consisting of geo-location, stack of chips, game level, stake similarity, play style, popularity of the player, speed of play desired, recency of prior play with the user, frequency of prior play, type and amount of social interaction, and social information.

6. The method of claim 1, wherein gathering further includes,
defining one or more buckets for each player attribute; and
categorizing each of the plurality of players into corresponding buckets based on their respective player attributes.

7. The method of claim 6, wherein the matching to identify a subset of players further includes,
matching the player attributes to the player selection parameters in a hierarchical manner using information from the corresponding one or more buckets till the subset of players are found.

8. The method of claim 1, wherein the matching to identify a subset of players further includes,
identifying the subset of players from the plurality of players currently playing the online game by matching one of the player selection parameters with corresponding player attributes; and
refining the subset of players by matching additional player selection parameters received in the request with corresponding player attributes of the identified subset of players, the player attributes of the refined subset of players matching the player selection parameters of the request.

9. The method of claim 1, further includes,
determining number of players currently playing the online game in a group in which the selected player is a member;
when the number of players currently in the group is less than a maximum number of players allowed for the online game,
providing a user interface to enable the user to join the subset of players in playing the online game; and
updating the number of players in the group, in substantial real-time, to account for the user joining the group.

10. The method of claim 9, wherein providing the user interface further includes providing options for rendering attributes of the user at the client device, in response to the user joining the selected player in playing the online game.

11. The method of claim 9, wherein the options include a visibility status option for controlling rendering or hiding of the attributes of the user that has joined the group of the selected player for playing the online game,
wherein any changes to the visibility status option of the user propagated to other players of the group in substantial real-time, the updated change visible to the players in the group upon a load or a refresh of the user interface.

12. The method of claim 2, wherein the user attributes includes a geo-location associated with the user generating the request.

13. The method of claim 12, further includes providing an option to adjust the geo-location of the user to a geo-location different from the geo-location associated with the user, the adjusted geo-location used along with other player selection parameters to identify the subset of the players for playing the online game at the adjusted geo-location.

14. The method of claim 1, wherein identifying the subset of the players further includes,
identifying an economy within a social network associated with the user generating the request; and
selecting the subset of the players that are part of the economy of the user.

15. The method of claim 1, wherein the subset of players within the list are sorted based on one or more player selection parameters prior to returning the list to the user in response to the request.

16. The method of claim 1, wherein number of players within the subset of players returned for rendering is based on one or more game-related parameters of the online game.

17. A method for recommending a list of players for playing an online game, comprising:
receiving a request to join the online game currently being played by a plurality of players, the request including one or more player selection parameters provided by a user generating the request, the player selection parameters defining filtering options for filtering the plurality of players currently playing the online game;
gathering player attributes associated with each of the plurality of players that are currently playing the online game, in substantial real-time, in response to the request received from the user; and
identifying a subset of players from the plurality of players by matching two or more of the player selection parameters with the player attributes of the plurality of players obtained in substantial real-time;
returning the subset of players as a list of recommended players for rendering on a user device;
receiving selection of one or more of the players from the list of recommended players to join for playing the online game;
determining if a maximum number of players for the online game has been reached by one or more groups in which the selected ones of the players are members; and
allowing the user to join a select one of the groups of the selected ones of the players in playing the online game when number of players in the select group is less than the maximum number of players allowed for the online game, the number of players in the group updated in substantial real-time to account for the user joining the group.

18. The method of claim 17, wherein the maximum number of players is specific and predefined for the online game.

19. The method of claim 17, wherein each of the plurality of players has played the online game at least once with the user.

20. The method of claim 17, wherein each of the plurality of players is not socially connected to the user.

21. The method of claim 17, wherein matching to identify a subset of players further includes,
identifying the subset of players from the plurality of players currently playing the online game by matching one of the player selection parameters received in the request with a corresponding player attribute; and
refining the subset of players by matching additional player selection parameters received in the request with corresponding player attributes of the identified subset of players, the player attributes of the refined subset of players matching the player selection parameters of the request.

22. The method of claim 17, wherein receiving the request includes analyzing the player selection parameters to identify one or more attributes of the user generating the request and one or more player attributes for selecting the subset of the players to join for playing the online game,
wherein the attributes of the user include at least a geo location, and the player attributes include the player selection parameters selected from a group consisting of geo-location, stack of chips, game level, stake similarity, play style, popularity of the player, speed of play desired, date and time of prior play with the user, frequency of prior play, type and amount of social interaction, and social information.

23. A non-transitory computer-readable storage medium embedding program instructions for recommending a list of players for playing an online game, the computer-readable storage medium including:
program instructions for receiving a request to join an online game currently being played by a plurality of players, the request including one or more player selection parameters provided by a user generating the request, the player selection parameters defining filtering options for filtering the plurality of players currently playing the online game;
program instructions for gathering, in substantial real-time, player attributes associated with each of the plurality of players that are currently playing the online game, in response to the request received from the user;
program instructions for identifying a subset of players from the plurality of players by matching at least two or more of the player selection parameters with the player attributes associated with each of the plurality of players; and
program instructions for returning the subset of players as a list of recommended players for rendering on a user device, the returned list including options for selecting one or more players by the user, the selection of the players by the user resulting in the user joining the selected players in playing the online game.
